(19) United States
(12) Patent Application Publication
(10) Pub. No.: US 2015/0098487 A1
(43) Pub. Date: Apr. 9, 2015

(54) Magnetostrictive Dual Temperature and Position Sensor

(71) Applicants: Ke Wang, Sugar Land, TX (US); Zhiyue Xu, Cypress, TX (US)

(72) Inventors: Ke Wang, Sugar Land, TX (US); Zhiyue Xu, Cypress, TX (US)

(73) Assignee: BAKER HUGHES INCORPORATED, HOUSTON, TX (US)

(21) Appl. No.: 14/328,427

(22) Filed: Jul. 10, 2014

Related U.S. Application Data
(63) Continuation-in-part of application No. 14/046,332, filed on Oct. 4, 2013.
Application No. 14/046,332 is a continuation-in-part of application No. 14/282,825, filed on May 20, 2014.

(51) Int. Cl. E21B 47/06; G01B 17/00; E21B 47/09; G01K 11/22

(52) U.S. Cl. CPC E21B 47/065; G01K 11/22; G01B 17/00; E21B 47/09
USPC 374/142

(57) ABSTRACT

A method of determining position and a temperature is disclosed. A test pulse is propagated along a longitudinal axis of a magnetostrictive rod having a plurality of longitudinally-spaced reflective features. Reflections of the ultrasonic test pulse are received from the reflective features and from a cursor coupled with the magnetostrictive rod. The received reflections are separated into one of a first set indicative of temperature and a second set indicative of position of the cursor. Temperature is determined from the first set of pulses, and the position of the cursor along the magnetostrictive rod is determined from the second set of pulses. Position and temperature measurements may be used to operate a downhole tool on a work string.

### CROSS REFERENCE TO RELATED APPLICATIONS

The present application is a continuation-in-part of U.S. application Ser. No. 14/046,332, filed Oct. 4, 2013 and is a continuation-in-part of U.S. application Ser. No. 14/282,825, filed May 20, 2014.

### BACKGROUND OF THE DISCLOSURE

1. Field of the Disclosure

The present invention is related to simultaneous monitoring of position and temperature and, in particular, to the use of magnetostrictive probe technology for obtaining simultaneous position and temperature measurement for use in the petroleum industry.

2. Description of the Related Art

Various tools are used on a work string disposed in a borehole in order to operate the work string. Such tools include, for example, electrical submersible pumps (ESPs), multi-stage fracturing tools and flow control devices such as valves, sleeves, pistons, switches, etc. These tools include moving parts that move in order to perform their intended purposes. For example, a valve may be opened or closed or a sleeve or piston will be moved based on a local or environmental temperature. For such operations, in general, a temperature sensor is used to determine temperature and a separate position sensor is used to determine tool position. Each sensor however takes up space on the work string and requires individual circuitry further concerning valuable space on the work string.

### SUMMARY OF THE DISCLOSURE

In one aspect, the present disclosure provides a method of determining position and a temperature, the method including: propagating a test pulse along a longitudinal axis of a magnetostrictive rod having a plurality of longitudinally-spaced reflective features; receiving reflections of the ultrasonic test pulse from the reflective features and from a cursor coupled with the magnetostrictive rod; and using a processor to: separate the received reflections into one of a first set indicative of temperature and a second set indicative of position of the cursor; determine the temperature from the first set, and determine the position of the cursor along the magnetostrictive rod from the second set.

In another aspect, the present disclosure provides a method of operating a downhole tool, the method including: coupling a magnetostrictive rod to a first portion of the tool, the magnetostrictive rod having a plurality of longitudinally-spaced reflective features; placing a second portion of the tool in contact with the magnetostrictive rod; propagating a test pulse along a longitudinal axis of the magnetostrictive rod; determining a temperature from the reflections of the test pulse from the reflective features; determining a position of the second portion of the tool with respect to the first portion of the tool from the reflection of the test pulse from the second portion of the tool; and moving the second portion of the tool with respect to the first portion of the tool based on the determined temperature and determined position to operate the downhole tool.

In yet another embodiment, the present disclosure provides a downhole system, including: a work string; a tool disposed on the work string, the tool including a first portion and a second portion movable with respect to the first portion; a magnetostrictive rod affixed to one of the first portion and the second portion, the magnetostrictive rod having a plurality of longitudinally-spaced reflective features; a cursor coupled to the magnetostrictive rod; a magnetostrictive transducer configured to transmit an ultrasonic test pulse along the magnetostrictive rod and to receive ultrasonic pulses resulting from reflection of the ultrasonic test pulse at the plurality of notches and at the cursor; a processor configured to: estimate a temperature from the received ultrasonic pulses resulting from reflection of the ultrasonic test pulse at the plurality of notches, determine a position of the cursor from the received ultrasonic pulses resulting from reflection of the ultrasonic test pulse at the cursor, and move the second component with respect to the first component based on the estimated temperature and the determined position.

Examples of certain features of the apparatus and method disclosed herein are summarized rather broadly in order that the detailed description thereof that follows may be better understood. There are, of course, additional features of the apparatus and method disclosed hereinafter that will form the subject of the claims.

### BRIEF DESCRIPTION OF THE DRAWINGS

For detailed understanding of the present disclosure, references should be made to the following detailed description, taken in conjunction with the accompanying drawings, in which like elements have been given like numerals and wherein:

FIG. 1 shows a downhole system that includes a sensor suitable for measuring a temperature and a position in order to control operation of the downhole system 100 in an exemplary embodiment of the disclosure;

FIG. 2 shows a detailed view of the exemplary sensor of FIG. 1;

FIG. 3 shows a set of pulses received at a magnetostrictive transducer of the sensor in response to a generated test pulse;

FIG. 4A illustrates a first embodiment of a downhole tool and sensor;

FIG. 4B illustrates a second embodiment of the downhole tool and sensor;

FIG. 5A shows an alternate embodiment of a sensor of the present disclosure; and

FIG. 5B shows a set of signal received at first magnetostrictive transducer due to reflection of a first set of test pulses along sensing rod.

### DETAILED DESCRIPTION OF THE DISCLOSURE

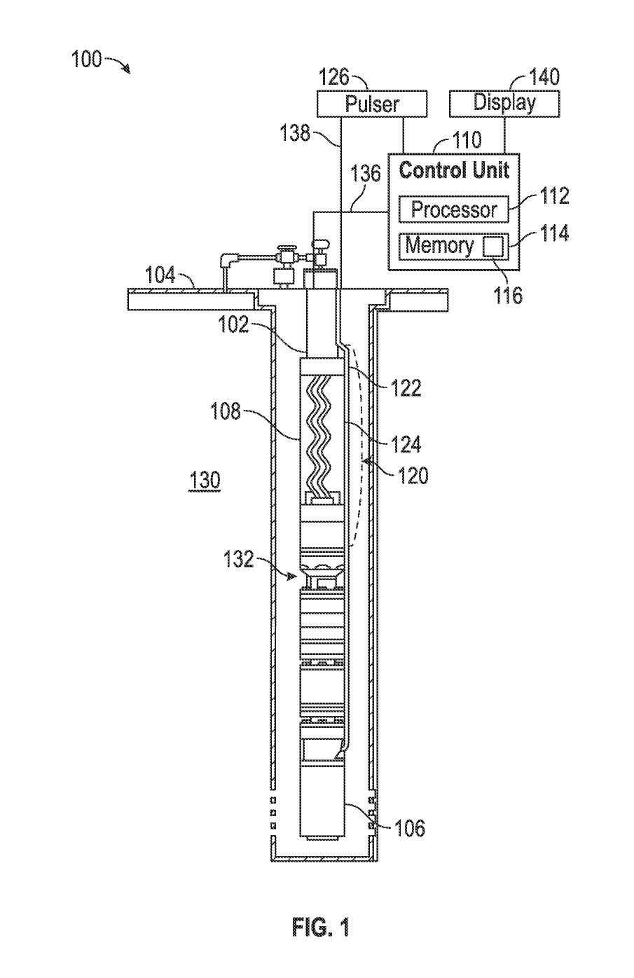

FIG. 1 shows a downhole system 100 that includes a sensor 120 suitable for measuring a temperature and a position in order to control operation of the downhole system 100 in an exemplary embodiment of the disclosure. The downhole system 100 includes a work string 102 disposed in a wellbore 132 formed in a formation 130. The work string 102 extends in the wellbore 132 from a surface location 104 to a downhole location 106. The work string 102 may include a drill string, a production string, a fracturing system including a multi-stage fracturing system, a perforation string, etc. A tool 108 for performing a downhole operation is conveyed to a selected depth of the wellbore by the work string 102. The tool 108 may be or contain a linear actuator, hydraulically actuated equipment, or may be another position sensitive downhole tool, for example. Further, the tool 108 may be an electrical submersible pump (ESP), a flow control device such as a valve, sleeve, piston or switch, a pneumatic cylinder control, a fracturing tool, etc. The tool 108 may be located at any suitable location along the work string 102. The tool 108 may be coupled to a control unit 110 via cable 136. Control unit 110 controls the tool 108 to perform various operations, such as drilling, fracking or acid stimulation, perforation, production, etc. The control unit 110 may control the tool 108 by moving or changing a position of a component, portion or segment of the tool 108. In various embodiments, the control unit 110 may be at a surface location 104 or at a suitable location in the work string 102. The control unit 110 includes a processor 112, a memory location or memory storage device 114 for storing data obtained from the downhole operation of the tool 108 or values of operational parameters of the tool 108, and one or more programs 116 stored in the memory storage device 114. The memory storage device 114 may be any suitable non-transitory storage medium such as a solid-state memory device, etc. When accessed by the processor 112, the one or more programs 116 enable the processor 110 to perform the methods disclosed herein for controlling operation of the tool 108 using downhole position and temperature measurements. Position and temperature measurements from the sensor 120 may be shown at display or monitor 140. Data from the sensor 120 may be stored downhole or may be sent to the surface without being stored downhole. Processing may occur downhole, uphole at the surface location 104 or at both such locations. Thus, the methods disclosed herein may be performed in a closed-loop downhole system, in situ, and in real-time, or alternatively on the surface.

The work string 102 may further include at least one sensor 120 for obtaining simultaneous measurements of position and temperature related to tool 108. The sensor 120 includes a magnetostrictive transducer 122 and a magnetostrictive sensing rod 124. The sensor 120 may be coupled to a pulser 126 via connector 138. The pulser 126 may send position and/or temperature data to control unit 110 to allow for closed loop operation of tool 108. The pulser 126 may send signals to activate the sensor 120 and receive from the position sensor 120 signals indicative of either a position relative to the magnetostrictive sensing rod 124, a downhole temperature or both. The signals related to position may be obtained for an actuated portion of tool 108 relative to a stationary portion of tool 108, wellbore 132, relative to work string 102 or any other suitable reference point, in various embodiments.

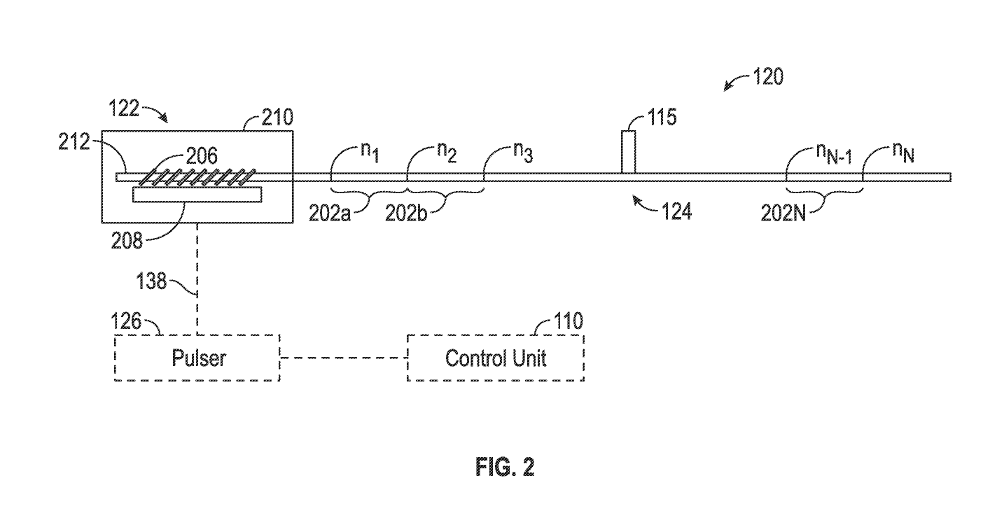

FIG. 2 shows a detailed view of the exemplary sensor 120 suitable for obtaining data indicative of temperature and/or position. The sensor 120 includes the magnetostrictive sensing rod 124 and the magnetostrictive transducer (MST) 122 coupled to the sensing rod 124. In an exemplary embodiment, a diameter of the sensing rod 124 may be less than about 1 millimeter (mm) and the length of the sensing rod 124 may be about 30 feet (about 10 meters). The sensing rod 124 may be made of a material, such as nickel/iron or Inconel, which is rust-resistant and suitable for use in a variety of environments. The sensing rod 124 may be oriented so as to extend along a section of the work string (102, FIG. 1).

Sensing rod 124 includes reflective elements such as notches (n₁, n₂, . . . , n_{N}) formed at axially spaced-apart locations along the sensing rod 124. In one embodiment, the notches may be separated by a few inches. In general, the notches (n₁, n₂, . . . n_{N}) are circumferential notches that are equally spaced along the longitudinal axis of the sensing rod 124 when the temperature of the sensing rod 124 is constant along the sensing rod 124. The notches (n₁, n₂, . . . n_{N}) divide the sensing rod 124 into segments or intervals (202a, 202b, . . . , 202N), wherein the intervals may have equal lengths when the temperature of the sensing rod 124 is constant along the sensing rod 124.

The MST 122 includes a housing 210 that contains therein a coil 206 and a magnet 208, which may be a permanent magnet. The magnet 208 and coil 206 serve to transform an electrical signal into an ultrasonic pulse for transmission of the ultrasonic pulse along the sensing rod 124. The magnet 208 and coil 206 also serve to transform received ultrasonic pulses from the sensing rod 124 (generally, but not necessarily, reflected ultrasonic pulses) into electrical signals. The electrical signals generated in response to receiving ultrasonic pulses are generally indicative of either a temperature along the sensing rod 124 or a position of a cursor 115 coupled to the sensing rod 124. An end portion 212 of the sensing rod 124 extends into the housing 210 and is wrapped by the coil 206. The coil 206 may be communicatively coupled to pulser 126 via connector 138. The connector 138 may be of a size suitable for a selected tool or operation. The pulser 126 may provide power and/or electrical signals to the coil 206 to generate an ultrasonic pulse. The pulser 126 sends an electrical signal to the coil 206 to generate a changing magnetic field, causing magnetostriction at the end portion 212 of the sensing rod 124 within the housing 210. The magnetostriction generates an outgoing ultrasonic pulse that propagates from the end portion 212 along the length of the sensing rod 124 in a direction away from the coil 206. As the outgoing ultrasonic pulse propagates along the sensing rod 124, each notch (n₁, n₂, . . . n_{N}) reflects a portion or percentage of the outgoing ultrasonic pulse back towards the MST 122. Additionally, the cursor 115 reflects a portion or percentage of the ultrasonic pulse. The remaining portion or percentage of the outgoing ultrasonic pulse continues its propagation along the sensing rod 124 away from the coil 206. A reflected ultrasonic pulse that is received at the MST 122 produces an electrical signal in the coil 206 which is sent to pulser 126 and on to the control unit 110. Because the sensing rod 124 includes a plurality of notches, the control unit 110 records a plurality of reflected signals, each corresponding to a selected notch in the sensing rod 124. The control unit 110 further records an electrical signal corresponding to the cursor 115.

As the temperature of the sensing rod 124 increases or decreases, the modulus of elasticity of the sensing rod 124 changes and therefore the velocity of sound for the signal propagating through the sensing rod 124 increases or decreases with temperature. Thus, determining the travel time between generating a pulse at a first location (e.g., at coil 206) and receiving back at the first location its reflection from a second location (e.g., a selected notch such as notch n₁) may be used to determine a temperature at the second location (e.g., notch n₁). The increased velocity at elevated temperatures reduces the travel time for the ultrasonic pulse between the first location and the second location. Therefore, the temperature may be determined at a selected notch by comparing a travel time to a calibrated travel time for an ultrasonic pulse at a known reference temperature. Additionally, a difference in a first travel time determined with respect to a first notch (e.g., notch n₁) and a second travel time determined with respect to a second adjacent notch (e.g., notch n₂) may be used to determine a temperature along a segment (e.g., segment 202a) between the two notches. Although a length of the sensing rod 124 may also increase or decrease with temperature, the effect of such changes in length on temperature measurements are substantially negligible.

Position measurements may be obtained between the MST 122 and the cursor 115. As the outgoing ultrasonic test pulse propagates along the magnetostrictive sensing rod 124, the cursor 115 reflects the outgoing ultrasonic pulse back towards the MST 122. A time difference between the generated test pulse and the received reflection from the cursor 115 may be used along with a known velocity of the test pulse to determine the position of the cursor 115. In various embodiments, the velocity of the test pulse may be corrected for the effects of temperature on the pulse velocity using for example, the determined temperature. The corrected velocity may then be used to determine position of the cursor 115. In another embodiment, the reflection pulse from the cursor 115 may be compared to the reflection pulses from the reflective elements (n₁, n₂, . . . , n_{N}) in order to determine the location of the cursor 115 with respect to the reflective elements (n₁, n₂, . . . , n_{N}).

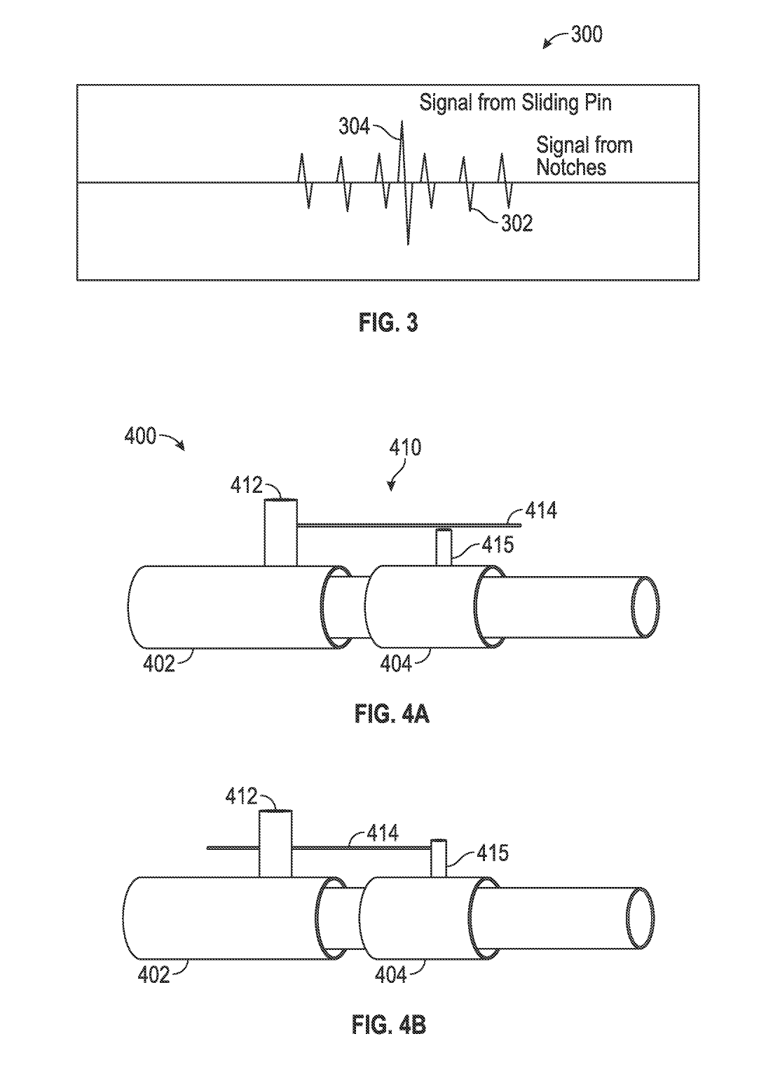

FIG. 3 shows a set of pulses received at MST 122 in response to a generated test pulse. The set of pulses includes a first set of pulses 302 related to reflection from the reflective elements (n₁, n₂, . . . , n_{N}) and a second set of pulses 304 related to reflection from cursor 215. Control unit (110, FIG. 1) may be configured to determine whether a reflected pulse is reflected from one of the reflective elements (n₁, n₂, . . . , n_{N}) or from the cursor 115. Control unit (110, FIG. 1) may determine that an amplitude of a reflection from the cursor 115 is within one range of values while an amplitude of a reflection from one of the reflective elements (n₁, n₂, . . . , n_{N}) is within another range of values. Additionally, reflections from the reflective elements (n₁, n₂, . . . , n_{N}) may have a noticeable and/or determinable periodicity. Meanwhile a reflection from the cursor 115 may have a substantially non-periodic relation with the reflections from the reflective elements (n₁, n₂, . . . , n_{N}) and motion of the cursor 115 may be determined using multiple test pulses.

FIG. 4A illustrates a first embodiment of a downhole tool and sensor. The tool 400 includes a first component 402 (also referred to herein as a first portion or a first segment) and a second component 404 (also referred to herein as a second portion or a second segment) movable with respect to the first component 402. In the illustrative embodiment, the first component 402 is a tubular member and the second component 404 is a sleeve of the tubular member. The sensor 410 includes MST 412 and sensor rod 414 affixed to the first component 302. The sensor rod 414 extends along a longitudinal axis of the first component 402. Cursor 415 is affixed to the second component 304 and moves along the sensor rod 414 as the second component 404 moves with respect to the first component 402. In this configuration, the sensor 410 may obtain temperature measurements of the downhole environment as well as position measurements of the second component 404 relative to the first component 402.

FIG. 4B illustrates a second embodiment of the downhole tool and sensor. MST 412 is affixed to first component 402 and cursor 415 is affixed to second component 404. Sensor rod 414 is affixed to cursor 415 and the sensor rod 414 slides along MST 412 as the first component 402 and second component 404 move with respect to each other.

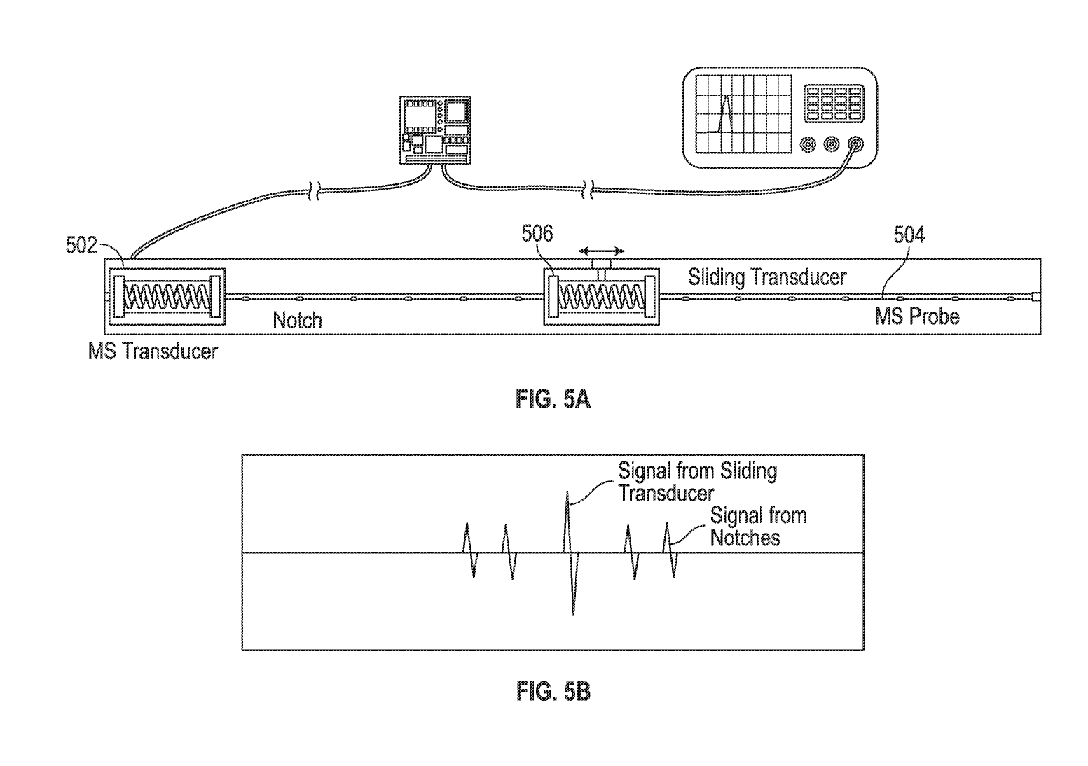

FIG. 5A shows an alternate embodiment of a sensor 500 of the present disclosure. Sensor 500 includes first MST 502 and sensing rod 504. The first MST 502 is motionless with respect to sensing rod 504 and propagates a first set of test pulses along sensing rod 504. A second MST 506 slides along the sensing rod 504 and propagates a second set of test pulses along sensing rod 504. Second MST 506 reflects the first set of test pulses propagated from the first MST 502 and therefore acts as a cursor with respect to first MST 502. The first set of test pulses can thus be used to determine the position of the second MST 506 with respect to the first MST 502. Similarly, first MST 502 reflects the second set of test pulses propagated from the second MST 506 and therefore acts as a cursor with respect to second MST 506. The second set of test pulses can thus be used to determine the position of the first MST 502 with respect to the second MST 506. FIG. 5B shows a set of signal received at first MST 502 due to reflection of a first set of test pulses along sensing rod 504.

Therefore in one aspect, the present disclosure provides a method of determining position and a temperature, the method including: propagating a test pulse along a longitudinal axis of a magnetostrictive rod having a plurality of longitudinally-spaced reflective features; receiving reflections of the ultrasonic test pulse from the reflective features and from a cursor coupled with the magnetostrictive rod; and using a processor to: separate the received reflections into one of a first set indicative of temperature and a second set indicative of position of the cursor; determine the temperature from the first set, and determine the position of the cursor along the magnetostrictive rod from the second set. The ultrasonic test pulse may be propagated from a magnetostrictive transducer at a selected location along the magnetostrictive rod and receiving the reflections at the magnetostrictive transducer. The magnetostrictive rod is affixed to a first portion of a tool and the cursor is affixed to a second portion of the tool movable with respect to the first portion of the tool. The first portion of the tool may be moved with respect to the second portion of the tool based on the estimated temperature and the determined position of the cursor along the magnetostrictive rod. In one embodiment, the magnetostrictive transducer is movable with respect to the magnetostrictive rod and the cursor is affixed to the magnetostrictive rod. In another embodiment the magnetostrictive transducer is affixed to the magnetostrictive rod and the cursor is movable with respect to the magnetostrictive rod. In yet another embodiment, the cursor is another magnetostrictive transducer.

In another aspect, the present disclosure provides a method of operating a downhole tool, the method including: coupling a magnetostrictive rod to a first portion of the tool, the magnetostrictive rod having a plurality of longitudinally-spaced reflective features; placing a second portion of the tool in contact with the magnetostrictive rod; propagating a test pulse along a longitudinal axis of the magnetostrictive rod; determining a temperature from the reflections of the test pulse from the reflective features; determining a position of the second portion of the tool with respect to the first portion of the tool from the reflection of the test pulse from the second portion of the tool; and moving the second portion of the tool with respect to the first portion of the tool based on the determined temperature and determined position to operate the downhole tool. The test signal may be propagates from a magnetostrictive transducer affixed to the first portion of the tool. The second portion of the tool may include a position cursor coupled to the magnetostrictive rod. The position cursor may be another magnetostrictive transducer. In one embodiment, the magnetostrictive transducer is movable with respect to the magnetostrictive rod and the cursor is affixed to the magnetostrictive rod. In another embodiment, the magnetostrictive transducer is affixed to the magnetostrictive rod and the cursor is movable with respect to the magnetostrictive rod. Moving the second portion of the tool with respect to the first portion of the tool may includes, for example, opening a valve; closing a valve; moving a sleeve on a work string; flipping a switch; moving a piston; releasing a fluid; altering an operation of an electrical submersible pump; and altering a parameter of a fracturing operation.

In yet another embodiment, the present disclosure provides a downhole system, including: a work string; a tool disposed on the work string, the tool including a first portion and a second portion movable with respect to the first portion; a magnetostrictive rod affixed to one of the first portion and the second portion, the magnetostrictive rod having a plurality of longitudinally-spaced reflective features; a cursor coupled to the magnetostrictive rod; a magnetostrictive transducer configured to transmit an ultrasonic test pulse along the magnetostrictive rod and to receive ultrasonic pulses resulting from reflection of the ultrasonic test pulse at the plurality of notches and at the cursor; a processor configured to: estimate a temperature from the received ultrasonic pulses resulting from reflection of the ultrasonic test pulse at the plurality of notches, determine a position of the cursor from the received ultrasonic pulses resulting from reflection of the ultrasonic test pulse at the cursor, and move the second component with respect to the first component based on the estimated temperature and the determined position. In one embodiment, the transducer and the magnetostrictive rod are affixed to the first portion of the tool and the cursor is movable with respect to the magnetostrictive rod. In another embodiment, the transducer is affixed to the first portion of the tool and the magnetostrictive rod and the cursor are movable with respect to the transducer. The cursor may include another magnetostrictive transducer. In various embodiments, the tool includes at least one of: (i) a valve; (iii) a sleeve of the work string; (iv) a switch; (v) a piston; and (vii) an electrical submersible. In various embodiments, the work string includes at least one of (i) a fracturing work string; (ii) a drill string; (iii) a completion string; and (iv) a production string.

While the foregoing disclosure is directed to the certain exemplary embodiments of the disclosure, various modifications will be apparent to those skilled in the art. It is intended that all variations within the scope and spirit of the appended claims be embraced by the foregoing disclosure.

1. A method of determining position and a temperature, comprising:
propagating a test pulse along a longitudinal axis of a magnetostrictive rod having a plurality of longitudinally-spaced reflective features;
receiving reflections of the ultrasonic test pulse from the reflective features and from a cursor coupled with the magnetostrictive rod; and
using a processor to:
separate the received reflections into one of a first set indicative of temperature and a second set indicative of position of the cursor;
determine the temperature from the first set, and
determine the position of the cursor along the magnetostrictive rod from the second set.

2. The method of claim 1 further comprising propagating the ultrasonic test pulse from a magnetostrictive transducer at a selected location along the magnetostrictive rod and receiving the reflections at the magnetostrictive transducer.

3. The method of claim 1, wherein the magnetostrictive rod is affixed to a first portion of a tool and the cursor is affixed to a second portion of the tool movable with respect to the first portion of the tool.

4. The method of claim 3, further comprising moving the first portion of the tool with respect to the second portion of the tool based on the estimated temperature and the determined position of the cursor along the magnetostrictive rod.

5. The method of claim 1, wherein the cursor is another magnetostrictive transducer.

6. The method of claim 1, wherein the magnetostrictive transducer is movable with respect to the magnetostrictive rod and the cursor is affixed to the magnetostrictive rod.

7. The method of claim 1, wherein the magnetostrictive transducer is affixed to the magnetostrictive rod and the cursor is movable with respect to the magnetostrictive rod.

8. A method of operating a downhole tool, comprising:
coupling a magnetostrictive rod to a first portion of the tool, the magnetostrictive rod having a plurality of longitudinally-spaced reflective features;
placing a second portion of the tool in contact with the magnetostrictive rod;
propagating a test pulse along a longitudinal axis of the magnetostrictive rod;
determining a temperature from the reflections of the test pulse from the reflective features;
determining a position of the second portion of the tool with respect to the first portion of the tool from the reflection of the test pulse from the second portion of the tool; and
moving the second portion of the tool with respect to the first portion of the tool based on the determined temperature and determined position to operate the downhole tool.

9. The method of claim 8, further comprising propagating the test signal from a magnetostrictive transducer affixed to the first portion of the tool.

10. The method of claim 8, wherein the second portion of the tool includes a position cursor coupled to the magnetostrictive rod.

11. The method of claim 10, wherein the position cursor is another magnetostrictive transducer.

12. The method of claim 8, wherein the magnetostrictive transducer is movable with respect to the magnetostrictive rod and the cursor is affixed to the magnetostrictive rod.

13. The method of claim 8, wherein the magnetostrictive transducer is affixed to the magnetostrictive rod and the cursor is movable with respect to the magnetostrictive rod.

14. The method of claim 8, wherein moving the second portion of the tool with respect to the first portion of the tool further comprises at least one of: (i) opening a valve; (ii) closing a valve; (iii) moving a sleeve on a work string; (iv) flipping a switch; (v) moving a piston; (vi) releasing a fluid; (vii) altering an operation of an electrical submersible pump; (viii) altering a parameter of a fracturing operation.

15. A downhole system, comprising:
a work string;
a tool disposed on the work string, the tool including a first portion and a second portion movable with respect to the first portion;
a magnetostrictive rod affixed to one of the first portion and the second portion, the magnetostrictive rod having a plurality of longitudinally-spaced reflective features;
a cursor coupled to the magnetostrictive rod;
a magnetostrictive transducer configured to transmit an ultrasonic test pulse along the magnetostrictive rod and to receive ultrasonic pulses resulting from reflection of the ultrasonic test pulse at the plurality of notches and at the cursor;
a processor configured to:
estimate a temperature from the received ultrasonic pulses resulting from reflection of the ultrasonic test pulse at the plurality of notches,
determine a position of the cursor from the received ultrasonic pulses resulting from reflection of the ultrasonic test pulse at the cursor, and
move the second component with respect to the first component based on the estimated temperature and the determined position.

16. The downhole system of claim 15, wherein the transducer and the magnetostrictive rod are affixed to the first portion of the tool and the cursor is movable with respect to the magnetostrictive rod.

17. The downhole system of claim 15, wherein the transducer is affixed to the first portion of the tool and the magnetostrictive rod and the cursor are movable with respect to the transducer.

18. The downhole system of claim 15, wherein the cursor further comprises another magnetostrictive transducer.

19. The downhole system of claim 15, wherein the tool further comprises at least one of: (i) a valve; (iii) a sleeve of the work string; (iv) a switch; (v) a piston; and (vii) an electrical submersible.

20. The downhole system of claim 15, wherein the work string further comprises at least one of (i) a fracturing work string; (ii) a drill string; (iii) a completion string; and (iv) a production string.
